(19) United States
(12) Patent Application Publication
(10) Pub. No.: US 2009/0069551 A1
(43) Pub. Date: Mar. 12, 2009

(54) Flavorant Compounds

(76) Inventors: Thomas Frank Hofmann, Neufahrn (DE); Bernd Schwarz, Schermbeck (DE)

Correspondence Address: CURATOLO SIDOTI CO., LPA, 24500 CENTER RIDGE ROAD, SUITE 280, CLEVELAND, OH, 44145, US

(21) Appl. No.: 12/298,316

(22) PCT Filed: Apr. 27, 2007
(86) PCT No.: PCT/CH07/00205

§ 371 Date: Oct. 24, 2008

(30) Foreign Application Priority Data
May 4, 2006 (GB) 0608688.8

(51) Int. Cl. C07G 3/00

(52) U.S. Cl. 536/4.1

(57) ABSTRACT

A compound of the Formula (I) wherein A is selected from the group consisting of —CH═CH—CO—CH3 and —CH2CH2—CO—CH3. The compounds are useful as flavorants in compositions such as foodstuffs, beverages, confectionery, medicinal preparations, dentifrices and mouthwashes.

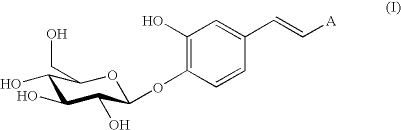

This invention relates to organic compounds and uses therefor.

The invention provides a compound of the Formula I:

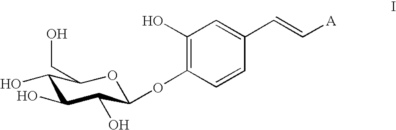

wherein A is selected from the group consisting of —CH═CH—CO—CH3 and —CH2CH2—CO—CH3.

The two compounds covered by this definition are:

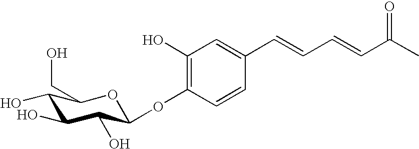

(3E,5E)-6-[3-Hydroxy-4O-β-D-glucopyranoside-phenyl]-hexa-3,5-dien-2-one

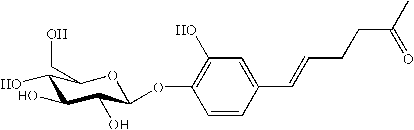

(E)-6-(3-hydroxyphenyl)-(4-O-β-D-glucopyranoside)hex-5-en-2-one

The compounds occur naturally and are present in, and can be isolated from, red currant juice. They have an astringent, mouth-coating velvety and mouth drying taste and are useful in flavorants in foodstuffs, beverages and other compositions taken or ingested orally, such as toothpastes, mouthwashes ands medicinal preparations. (E)-6-(3-hydroxyphenyl)-(4-O-β-D-glucopyranoside)hex-5-en-2-one and (3E,5E)-6-[3-Hydroxy-4-O-β-D-glucopyranoside-phenyl]-hexa-3,5-dien-2-one were found to induce an astringent sensation at very low threshold concentrations, ranging from 4.0 to 4.3 μmol/L, which are about 100 times lower than the threshold concentration of catechin.

The invention therefore also provides a method of imparting an astringent flavour to a composition to be taken orally, comprising the addition thereto of at least one compound according to the formula I.

The invention additionally provides a composition having an astringent flavour, comprising at least one compound according to the Formula I.

Compositions in which the compounds of this invention are useful include foodstuffs and beverages of all kinds, baked goods, confectionery products including chewing gum and hard candy, medicinal products in solid, liquid, powder, spray, tablet and lozenge form, dentifrices, including toothpastes, toothgels and mouthwashes. Apart from the compounds hereinabove described, such compositions are entirely conventional in their formulation, and all of the known standard ingredients may be used in art-recognised quantities. The incorporation of the compounds to give the composition of the invention is also entirely conventional and can be achieved by standard methods of the art.

The invention is now further described with reference to the following non-limiting examples.

### EXAMPLE 1

### Obtaining of (E)-6-(3-hydroxyphenyl)-(4-O-β-D-glucopyranoside)hex-5-en-2-one

Approximately 100 g of red currant puree is extracted under stirring with 400 mL methanol. After filtration, the residue is extracted twice with 300 mL methanol/water (70:30), adjusted to pH 4.0 with 1% formic acid while stirring for 1 hour at 40° C. Combined aqueous methanol solution is freed from organic solvent in vacuum. The aqueous solution is extracted three times with ethyl acetate (300 mL each). Combined organic layers are evaporated in vacuum. The residue is taken up in water and freeze-dried (ethyl acetate fraction).

Approximately 500 mg of the ethyl acetate fraction is mixed with methanol/water (40:60) and placed on the top of a water-cooled glass column filled with a slurry of Sephadex™ LH 20, which is conditioned with a water-methanol mixture (60/40) at pH 4.5 with 1% formic acid. A stepwise water-methanol gradient beginning with 40% to 100% is performed (using a flow rate of approximately 3 mL/min). Fractions are collected by a fraction collector and the effluent monitored by means of an UV/VIS detector operating at a wavelength of λ=272 nm. The fractions are freed from organic solvent, freeze-dried and used for sensory analysis.

The GPC fractions 4 and 5 are evaluated with high scores for astringency and sourness. The separation of the combined fractions 4 and 5 by means of semi-preparative RP-HPLC yields fractions most astringent in taste. Furthermore preparative high performance liquid chromatography is performed in order to obtain enough material of the tastants in fraction 22, and 23 for their spectroscopic structure elucidation.

Identification of tastant in fraction 22 as (E)-6-(3-hydroxyphenyl)-(4-O-β-D-glucopyranoside)hex-5-en-2-one:

¹H NMR (400 MHz, MeOD; COSY) δ/ppm: Numbering of carbon atoms as seen below: 2.06 [s, 3H, H-C(1)], 2.30 [m, 2H, H-C(4)], 2.54 [t, 2H, J=7.5 Hz, H-C(3)], 3.31 [m, 1H, H-C(4′)], 3.34 [m, 1H, H-C(5′)], 3.38 [m, 1H, H-C(3′)], 3.40 [m, 1H, H-C(2′)], 3.61 [dd, 1H, J=5.7, 12.1 Hz, H-C(6a′)], 3.83 [dd, 1H, J=2.0, 12.1 Hz, H-C(6b′)], 4.65 [d, 1H, J=7.5 Hz, H-C(1′)], 5.96 [m, 1H, H-C(5)], 6.20 [d, 1H, J=16.3 Hz, H-C(6)], 6.65 [d, 1H, J=8.4 Hz, H-C(2*)], 6.79 [dd, 1H, J=2.0, 8.4 Hz, H-C(6*)], 7.16 [d, 1H, J=2.0 Hz, H-C(5*)]; ¹³C NMR (100 MHz, MeOD; HMQC, HMBC) δ/ppm: Numbering of carbon atoms as seen below: 60.6 [C(6′)], 26.8 [C(4)], 28.3 [C(1)], 42.3 [C(3)], 61.1 [C(6)], 70.1 [C(4′)], 73.5 [C(3′)], 75.6 [C(2′)], 77.3 [C(5′)], 103.0 [C(1′)], 114.8 [C(5*)], 115.4 [C(2*)], 121.6 [C(6*)], 125.9 [C(5)], 126.2 [C(1*)], 129.8 [C(6)], 144.9 [C(4*)], 146.6 [C(3*)], 209.6 [C(2)].

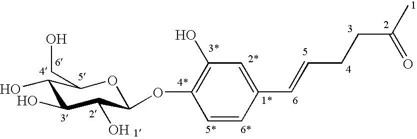

### EXAMPLE 2

### (3E,5E)-6-(3-hydroxy-4-O-β-D-glucopyranoside-phenyl)hexa-3,5-dien-2-one, isolated from fraction 23

¹H NMR (400 MHz, MeOD; COSY) δ/ppm: Numbering of carbon atoms as seen below: δ2.20 [s, 3H, H-C(1)], 3.27 [m, 1H, H-C(3′)], 3.38 [m, 1H, H-C(4′)], 3.39 [m, 1H, H-C(5′)], 3.42 [m, 1H, H-C(2′)], 3.60 [dd, 1H, J=6.6, 11.9 Hz, H-C(6a′)], 3.86 [dd, 1H, J=2.2, 11.9 Hz, H-C(6b′)], 4.71 [d, 1H, J=7.3 Hz, H-C(1′)], 6.14 [d, 1H, J=15.7 Hz, H-C(3)], 6.74 [d, 1H, J=8.4 Hz, H-C(5*)], 6.82 [dd, 1H, J=10.2, 15.4 Hz, H-C(5)], 6.86 [d, 1H, J=15.4 Hz, H-C(6)], 7.02 [dd, 1H, J=2.0, 8.4 Hz, H-C(6*)], 7.32 [dd, 1H, J=10.2, 15.7 Hz, H-C(4)], 7.43 [d, 1H, J=2.9 Hz, H-C(2*)]; ¹³C NMR (100 MHz, MeOD; HMQC, HMBC) δ/ppm: Numbering of carbon atoms as seen below: δ25.5 [C(1)], 61.1 [C(6′)], 70.1 [C(3′)], 73.4 [C(2′)], 76.1 [C(5′)], 77.4 [C(4′)], 103.0 [C(1′)], 115.7 [C(2*)], 115.9 [C(5*)], 123.7 [C(1*)], 123.8 [C(6*)], 124.3 [C(5)], 128.5 [C(3)], 141.8 [C(6)], 145.5 [C(4)], 145.5 [C(4*)], 148.3 [C(3*)], 200.1 [C(2)].

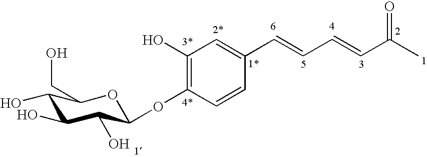

Sensorial taste evaluation of (E)-6-(3-hydroxyphenyl)-(4-O-β-D-glucopyranoside)hex-5-en-2-one and (3E,5E)-6-[3-Hydroxy-4-O-β-D-glucopyranoside-phenyl]-hexa-3 ,5-dien-2-one

For evaluation of taste thresholds of the isolated substances, a modified duo test is used. Therefore the substance solution is presented to a sensory panel in a duo test in increasing order, till at least two dilutions did not show any taste activity. As astringent substances can remain longer on the tongue or possibly can be fortified by addition of tap water, the assessed dilutions (tap water and assay) were given on two different regions of the tongue to compare the taste impressions. The panelists had to determine the dilution at which a difference between sample and tap water could be found.

| | taste | taste threshold | isoastringency:¹ |
|---|---|---|---|
| (E)-6-(3- | Mouth- | 4.3 μmol/L | 120 μmol/L |
| hydroxyphenyl)-(4-O- | coating | | |
| β-D- | Velvety, | | |
| glucopyranoside)hex-5- | drying | | |
| en-2-one | | | |
| (3E,5E)-6-[3- | Mouth- | 4.0 μmol/L | 200 μmol/L |
| Hydroxy-4-O-β-D- | coating | | |
| glucopyranoside- | Velvety, | | |
| phenyl]-hexa-3,5-dien- | drying | | |
| 2-one | | | |

¹concentration (μmol/L) needed to reach isointensity of astringent perception with a 700 μM aqueous catechin solution (pH 4.5)

1. A compound of the Formula I: 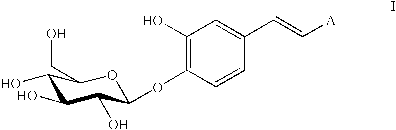
wherein A is selected from the group consisting of —CH═CH—CO—CH3 and —CH2CH2—CO—CH3.

2. A compound according to claim 1, in which the compound is 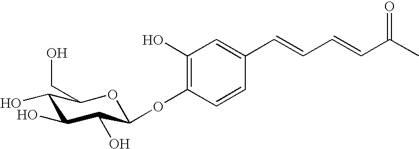
(3E,5E)-6-[3-Hydroxy-4-O-β-D-glucopyranoside-phenyl]-hexa-3,5-dien-2-one

3. A compound according to claim 1, in which the compound is 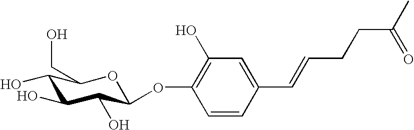
(E)-6-(3-hydroxyphenyl)-(4-O-β-D-glucopyranoside)hex-5-en-2-one

4. A composition having an astringent flavour, comprising at least one compound according to claim 1.

5. A method of imparting an astringent flavour to a composition to be taken orally, comprising the addition thereto of at least one compound according to claim 1.
